(19) United States
(12) Patent Application Publication
(10) Pub. No.: US 2003/0190141 A1
(43) Pub. Date: Oct. 9, 2003

(54) Video information playback apparatus

(76) Inventor: Tetsuya Kaneshiro, Osaka (JP)

Correspondence Address: RATNERPRESTIA, P O BOX 980, VALLEY FORGE, PA, 19482-0980, US

(21) Appl. No.: 10/385,551

(22) Filed: Mar. 11, 2003

(30) Foreign Application Priority Data
Mar. 20, 2002 (JP) 2002-78374

(51) Int. Cl. H04N 5/91; H04N 7/00

(52) U.S. Cl. 386/46; 386/68

(57) ABSTRACT

A video information playback apparatus includes a ring placed around a rotary knob with which a user manipulates jog or shuttle operation. A controller in the apparatus sends a signal to an illuminating section behind the ring depending on the jog or shuttle function selected, so that the illuminating section emits light through the ring. This structure allows the user to recognize which function is now in use.

### FIELD OF THE INVENTION

The present invention relates to video information playback apparatuses such as a business-grade videotape playback apparatus used in broadcasting stations or production companies.

### BACKGROUND OF THE INVENTION

Recently, broadcasting stations and production companies have been busy producing video-contents because the number of channels increases due to the availability of digital broadcastings using broadcasting satellites (BS), communication satellites (CS) and ground-wave. It is thus an urgent task to increase an efficiency in editing videos for a quick production of video-content, and an efficiency of video apparatuses has drawn attention from the industry. A conventional video information playback apparatus for editing videos is described hereinafter with reference to a videotape playback apparatus.

A conventional vide-tape playback apparatus includes a well-known jog and shuttle functions that playback a videotape. Those functions can be performed using one rotary knob in two operation modes. One of the operation modes is “jog function” that transports the tape frame-by-frame in response to rotating the rotary knob. To be more specific, this jog function links the rotary knob to a rotary encoder, and the encoder generates a unit pulse following a rotational angle of the knob. This unit pulse moves the videotape by one frame, so that frame-by-frame playback is carried out. For instance, when the knob is rotated clockwise, forward playback is carried out, and when the knob is rotated counter-clockwise, reversal playback is carried out. As a rotational angle increases or the number of rotations of the rotary knob increases, more frames are transported.

The other operation mode is “shuttle function” that changes a playback speed by turning a rotary knob, which is a type of “return-to-neutral point”, and the playback speed changes in response to an angle from the neutral point. To be more specific, the rotary knob is linked to a rebounding variable resistor or a rebounding encoder of return-to-neutral point type. For instance, when the knob is turned up to approx. 30 degrees from the neutral point to both sides, slow-playback (a tape is played back at a slower speed than the normal speed) is carried out. Then the knob is turned further until 90 degrees to either side, the playback speed increases gradually in step with the angle. When the knob is turned to 90 degrees (the max. point), fast-forward playback or rewinding playback is carried out, which transports the tape as fast as 20 times of the normal speed. When the knob is turned clockwise, forward playback is carried out, and when the knob is turned counter-clockwise, reversal playback is carried out.

The jog function and the shuttle function are embodied in one rotary knob so that users can manipulate those functions efficiently. The two functions can be switched, in general, by pressing the rotary knob along the rotary shaft. The torque of the rotary knob is transmitted to either one of the rotary encoder working for the jog function or to the element working for the shuttle function (the element is one of the variable resistor or the encoder of return-to-neutral point type.) This transmission is changed so that switching the jog mode to the shuttle mode is completed or vice versa.

However, users are sometimes in trouble to recognize which function is now in use, since the conventional structure discussed above provides one rotary knob with the two functions. For instance, a user turns the rotary knob in order to fast-forward a tape assuming that the user operates the shuttle function; in fact, the user actually operates the jog function, and the tape has been transported frame-by-frame instead of fast-forward. As a result, the user lost time in editing. On the contrary, when the user rotates the rotary knob in order to select videos frame by frame assuming that the user operates the jog function; in fact, the user actually operates the shuttle function. As a result, the tape runs a substantial length and the desired video moves far away time-wise.

### SUMMARY OF THE INVENTION

The video information playback apparatus of the present invention is equipped with the following elements:

playback means including

a first playback function that varies a speed of playing back video information recorded,

a second playback means that changes a position of playing back the video information; and

a controller for controlling an operation of the playback means.

The video information playback apparatus of the present invention structured above comprises the following elements:

(a) a rotary knob, coupled to the controller, for selecting one of the first playback function or the second playback function and carrying out the selected function;

(b) an illuminating section for changing an illuminating status, based on an instruction from the controller, corresponding to the function selected by the rotary knob; and

(c) a ring, disposed around an outer rim of the rotary knob, for transmitting the light from the illuminating section.

### BRIEF DESCRIPTION OF THE DRAWINGS

FIG. 1 shows a perspective view of a video information playback apparatus in accordance with an exemplary embodiment of the present invention.

FIG. 2 is a schematic diagram of the video information playback apparatus in accordance with the exemplary embodiment of the present invention.

### DETAILED DESCRIPTION OF THE EXEMPLARY EMBODIMENT

The present invention addresses the problem discussed above, and aims to provide a video playback apparatus that can notify users of which mode a rotary knob working for. The exemplary embodiment of the present invention is demonstrated hereinafter with reference to the accompanying drawings.

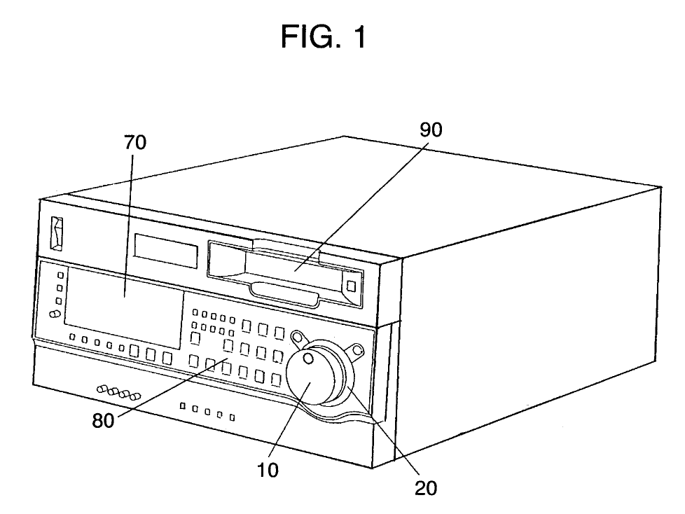

FIG. 1 shows a perspective view of the video information playback apparatus of the present invention. In FIG. 1, a user operates rotary knob 10 to carry out jog-playback or shuttle-playback. Translucent ring 20 is disposed around an outer rim of the rotary knob, and ring 20 transmits light emitted from illuminating section 30 behind ring 20 such that as if ring 20 emitted the light by itself Display section 70 indicates statuses of various devices equipped in the video information playback apparatus. For instance, it displays an operating mode of the apparatus such as “stop” and “play”, a counter and a time-code of playback, and a sound level at playback. Operation switches 80 include push buttons for “stop”, “play” and the like. A recorded medium is inserted into media-entrance 90 for playback.

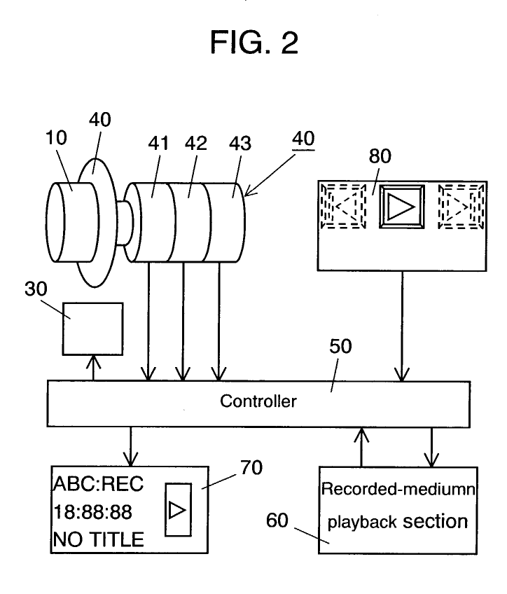

FIG. 2 is a schematic diagram of the video information playback apparatus in accordance with the exemplary embodiment of the present invention. In FIG. 2, rotary element 40 is formed of switch 41 that can be pressed along the shaft, rotary encoder 42 and rebounding element 43 of return-to-neutral point type. Switch 41 detects a push of rotary knob along the shaft, and sends a given signal to controller 50 based on the detection result. Signals supplied from rotary encoder 42 and rebounding element 43 are also sent to controller 50, which latches a signal supplied from switch 41, thereby changing an operation mode from the jog mode to the shuttle mode or vice versa. Controller 50 controls illuminating section 30 such that illuminating section emits light, or changes a color of the light depending on the operation mode. Illuminating section 30 is formed of light-emitting elements, such as LED, lamp, or E1, placed along the entire rim of ring 20 or parts of ring 20, and illuminates translucent ring 20 with its light emission.

Controller 50 follows the mode set by switch 41, and transmits a control signal to recorded-medium playback section 60 in response to an output from either one of rotary encoder 42 or rebounding element 43. Controller 50 thus controls the running of a tape (recorded medium) held in recorded-medium playback section 60.

As discussed above, this embodiment describes the case where two kinds of operation modes, namely, two types of playback functions are available. The first playback function is “shuttle function” that can change a speed of playing back recorded video information, and the second playback function is “jog function” that changes a position where the recorded video information is played back.

An operation of the video information playback apparatus structured above is further detailed hereinafter with reference to FIG. 1 and FIG. 2. First, a user puts a tape (not shown) storing contents to be edited into entrance 90, and loads the tape in tape-playback section 60. Next, the user operates switches 80, thereby transporting the tape just before a point where the edit starts. In this case, the tape is fast-forwarded or rewound by monitoring videos, therefore, the shuttle function is generally used for this playback. After the tape is transported just before an edit-starting point, the user switches the operation mode to the jog function from the shuttle function in order to specify the edit-starting point. The jog function allows the user to specify the edit-starting point with ease because the jog function transports the tape frame-by-frame.

Through those operations, ring 20 placed around rotary knob 10, which is manipulated for jog or shuttle function, changes illumination depending on the function in use. To be more specific, for instance, the jog function lights ring 20 in red, and the shuttle function does not light ring 20. This setting allows the user to recognize simply which function is now in use.

In the foregoing case, i.e., ring 20 illuminates in one operation mode and does not illuminate in another mode, sometimes a user misunderstands that ring 20 cannot illuminate because of a defective light-emitting element. Therefore, it is better to emit light in different colors depending on the operation mode. For instance, ring 20 lights in yellow or green in response to the operation mode. In the case of using two different colors, complementary colors (e.g. red and green) or colors close to complementary relation give the users better recognition.

This embodiment proves that illumination of ring 20 can tell the user which operation mode is in use now. However, in actual editing, operations are different depending on a user or an object of editing, for instance, producing a commercial film uses jog and shuttle functions with a different frequency from producing a program film. Therefore, some users prefer ring 20 illuminating during the jog function, and other users prefer ring 20 illuminating during the shuttle function. When two different colors are used, some users prefer ring 20 illuminating in red (drawing attention) during the jog operation, and the other color is thus assigned to the shuttle operation, or vice versa. Further, some user wants to change the illumination for himself or herself depending on a difference in a content of production or editing.

To meet those requests, users can operate switches 80 in advance to register various lighting combinations in controller 50. In this case, switches 80 in collaboration with controller 50 work as operation-switching means for changing a setting of illumination statuses of illuminating section 30.

Illuminating section 30 emits light not only during the jog or shuttle function, but also blinks in red for warning of, e.g., dewing a tape, or emits green light for noticing a user that no tape is loaded. In the fast-forward, or rewind operation, controller 50 also instructs ring 20 to increase the light emission as the tape-end or -lead is approaching. Since ring 20 lights itself entirely, the notice is positively given to the users.

The foregoing description refers to a video information playback apparatus; however, the present invention is applicable to any apparatus that can playback something, not to mention, applicable to a video information record and playback apparatus which can record video information in addition to the playback. In the foregoing description, a videotape is used as recorded medium; however, the present invention is applicable to optical disc, (DVD, Video), hard-disc, and semiconductor memory (SD memory card).

The present invention, as discussed above, changes a way of emitting light from the ring placed around the rotary knob in response to the jog mode or the shuttle mode, so that a user can recognize which mode is now in use. As a result, errors in operation can be reduced and more efficient video-editing can be expected.

What is claimed is:

1. A video information playback apparatus equipped with playback means including a first playback function that varies a speed of playing back video information recorded, a second playback means that changes a position of playing back the video information; and a controller for controlling an operation of the playback means, the video information playback means comprising:
(a) a rotary knob, coupled to the controller, for selecting one of the first playback function and the second playback function and carrying out the selected function;
(b) an illuminating section for changing an illuminating status, based on an instruction from the controller, corresponding to the function selected by the rotary knob; and
(c) a ring, disposed around an outer rim of the rotary knob, for transmitting the light from the illuminating section.

2. The video information playback apparatus of claim 1 further comprising operation-switching means for changing a setting of illuminating statuses of the illuminating section.
